(19) United States
(12) Patent Application Publication
(10) Pub. No.: US 2025/0216153 A1
(43) Pub. Date: Jul. 3, 2025

(54) METHOD FOR DRYING WOOD PRODUCTS IN ORDER TO PRODUCE WOOD PRODUCTS WITH REDUCED VOC EMISSIONS

(71) Applicant: FIBERBOARD GMBH, Baruth (DE)

(72) Inventors: Bernd BUNGERT, Baruth (DE); Thomas HEINE, Baruth (DE); Martin SCHWENDY, Baruth (DE); Christian DÜMICHEN, Baruth (DE); André HENNIG, Baruth (DE)

(21) Appl. No.: 18/848,747

(22) PCT Filed: Jul. 4, 2023
(86) PCT No.: PCT/EP2023/068350

§ 371 Date: Sep. 19, 2024

(30) Foreign Application Priority Data
Jul. 25, 2022 (EP) 22186666.8
Apr. 11, 2023 (DE) 10 2023 109 083.6

(51) Int. Cl. F26B 21/08; F26B 21/12; F26B 25/00; F26B 25/22

(52) U.S. Cl. CPC F26B 21/08; F26B 21/12; F26B 25/006; F26B 25/22; F26B 2200/24

(57) ABSTRACT

The disclosure relates to a method for drying wood products with reduced discharge of VOC.

### CROSS-REFERENCE TO RELATED APPLICATIONS

This application is a U.S. National Phase Application under 35 U.S.C. 371 of International Application No. PCT/EP2023/068350, filed on Jul. 4, 2023, which claims the benefit of European Patent Application No. 22186666.8, filed on Jul. 25, 2022, and German Patent Application No. 10 2023 109 083.6, filed on Apr. 11, 2023. The entire disclosures of the above European and German patent applications are incorporated herein by reference.

### FIELD

The disclosure relates to a process for drying wood products for producing wood products with reduced VOC emissions. The present disclosure relates in particular to a process for manufacturing wood products, wherein the process allows for improved removal of VOCs from the wood product, in particular from the wood, through an improved drying step.

### BACKGROUND

This section provides background information related to the present disclosure which is not necessarily prior art.

Regarding boards in the timber industry, such as particle boards, OSB boards, or pallets, but also in the manufacture of pellets from wood flakes or sawn timber, problems with emissions are known. These occur, for example, in the waste air after the drying and/or in the finished product itself. In the case of particle boards and OSB boards, for example, the so-called “Blue Haze” is known as a phenomenon of the exhaust gases. This describes aerosols of dust with condensing VOCs, especially terpenes. It is also generally known that particle boards and OSB boards emit VOCs in interior spaces.

Such emissions are, for example, primary emissions of substances contained directly in the products. Primary emissions may include, for example, constituents of the wood, such as terpenes, e.g. alpha-pinene, delta-3-carene, but also formaldehyde, for example from contained wood glue or organic acids, if finished boards are provided. In addition to the primary emissions, however, secondary emissions also occur, i.e. emissions of reaction products of the substances contained in the product, for example through reactions in the finished product, which might already be in use, or through reactions in the indoor air of primary emissions with other airborne compounds, such as the reactive species ozone, hydroxyl radicals, nitrous gases, or sulphur dioxide. One example are oxidation reactions of terpenes with ozone. In the reaction of the monoterpene limonene with ozone, for example, formic acid and acetic acid may be formed.

It is also known that wood contains fats or fatty acids. These are gradually reduced to aldehydes. Lead substances here are hexanoic acid and hexanal. As such, secondary emissions may consist of secondary constituents, such as aldehydes from the degradation of fats or fatty acids present in the wood, for example hexanoic acid from triglycerides, which can react to hexanal. Related substances include, for example, formaldehyde from formic acid, acetaldehyde from acetic acid, etc.

In the manufacture of particle boards, OSB boards, pallets, sawn timber, or laminated timber, for example, the manufacturing process is substantially “dry”, i.e. in contrast to the manufacture of MDF/HDF, for example, the processing is performed without any contact with water or steam. In the case of particle boards and OSB boards, a high temperature must be applied during drying due to the desired low residual moisture or target moisture. This results in high emissions of VOCs.

The manufacture of wood products thus still offers room for improvement.

### SUMMARY

This section provides a general summary of the disclosure, and is not a comprehensive disclosure of its full scope or all of its features.

It is an object of the present disclosure to provide a solution with which at least one disadvantage of the related art can be at least partially overcome. In particular, the object of the present disclosure is to provide a solution with which VOCs present in the wood can be removed particularly efficiently.

A process for drying wood products is described, wherein the process comprises the following process steps:
a) providing a wood product,
b) drying the wood product by thermal treatment; wherein process step b) is performed in two stages and comprises at least the following steps:
b1) if applicable, adding steam to the wood product and drying the wood product by removing a first amount of steam, in particular by partial steam distillation; and
b2) drying the wood product by removing a second amount of steam until a predeterminable target moisture is reached, wherein
in process step b1) steam is, if applicable, added in a predetermined first range of amounts and removed in a predetermined second range of amounts such that a lower limit and an upper limit of at least one of the first range of amounts and the second range of amounts are chosen depending on at least one specification of the wood product provided in process step a).

Such a process allows in a particularly advantageous way to efficiently reduce the environmentally harmful and/or health-damaging VOC emissions during the manufacture and/or application of wood products. This allows a low-emission further processing and applicability of the wood products and also a use of the VOCs removed from the wood without any issues.

Within the meaning of the present disclosure, the term VOC (volatile organic compounds) refers, in particular, to such volatile compounds that are present in the wood serving as the starting material for the process described herein. In particular, the VOCs described in this process are terpenes, which occur as wood oil in the wood. Examples include the following substances, which may, for example, occur in the percentages by weight given in brackets based on the VOCs contained: α-pinene (20 to 70%), β-pinene, (5 to 20%), limonene (1 to 5%), camphene (1 to 5%), phenol (0.2 to 2%). Further components may include myrcene, α-, β-phellandrene, 3-carene, cymene, terpinolene, and ocimene. Furthermore, VOCs may be understood to include organic acids present as free acids or bound as fats, typically as triglycerides, such as formic acid, acetic acid, hexanoic acid, etc. Within the meaning of the present disclosure, VOCs also include the corresponding subgroups, in particular VVOC (very volatile organic compounds), SVOC (semi-volatile organic compounds), and MVOC (microbial volatile organic compounds).

The process described herein serves to produce dried wood-containing products, also referred to as wood products, and in particular to dry wood-containing products. A product may be understood to be a final product or an intermediate product that requires further processing to become a final product. Furthermore, the term wood-containing product or wood product is understood to mean that the product comprises wood at least partially or consists only of wood. Examples include WPC (wood plastic composite) products.

According to process step a), the process described herein includes providing a wood product. As described above, within the meaning of the disclosure, the wood products may be intermediate products or final products. Examples include OSB boards, particle boards, pallets, flexboard products, i.e. insulation batts and insulation rolls, or also pellets or sawn timber. Also, fibreboards manufactured using a dry process may be used, for example with a raw density of less than 650 kg/m³, which may be referred to as light MDF (LDF), or a raw density of less than 550 kg/m³, which may be referred to as ultra-light MDF (ULDF). In principle, the wood products may include products produced using a dry process. In contrast to a wet process, with which for example traditional MDF boards are manufactured, a dry process may be understood to be one in which no water is added during manufacturing. A dry process within the meaning of the present disclosure is therefore, in particular, a process in which the wood product after being provided in the form of chunky parts or particles smaller than the tree trunk or sections of the tree trunk, i.e. wood chips, flakes, strands, or sawn timber, are not further treated with liquid or vaporous water, as is typically the case, for example, in the manufacture of MDF/HDF during boiling at elevated temperatures upstream of the refiner. Excluded from this treatment, however, is the addition of wood glue or paraffin emulsion in aqueous suspensions or emulsions. In a dry process, however, the suspending of wood chips in liquid water or the heating of chunky parts with water or steam is absent.

The wood used is not limited in general, for example, wood may be used that is selected from pine wood, spruce wood, larch wood, birch wood, beech wood, dead oak wood, alder wood, etc., however without being limited to this.

Although the wood product has been produced, in particular, in a dry process and therefore generally has a comparatively low dry content, a drying step is usually provided due to the desired very low final moisture. Such a drying step is realized in the process described herein according to process step b). In particular, process step b) includes drying the wood product by thermally treating it, i.e. under the influence of temperatures higher than room temperature. For this purpose, the wood product may, in general, be treated in a dryer.

More specifically, the drying or process step b) according to the present disclosure is designed to have two stages and includes the process steps b1) and b2). Preferably, the process steps b1) and b2) may be performed in two consecutive, for example immediately consecutive, drying devices or in separate drying areas. As drying devices, for example, known drum dryers may be used, for example with built-in coiled tubes.

When using particle boards, for example, a partial steam distillation may be performed as step b1) in a knife-ring flaker, during the, for example pneumatic, conveying to the dryer, in a screw device, in a belt dryer, in a, preferably small, drum dryer, or the like.

According to process step b1), as a first drying step, adding steam to the wood product and drying the wood product by removing a first amount of steam are optionally performed. In principle, the first amount of steam may be introduced under substantial exclusion of air by evaporating the partial amount of steam based on the water contained in the wood. In other words, the water used for process step b1) may come entirely from the wood to be dried, which, as described in greater detail below, may be determined depending on at least one specification of the wood product provided in process step a). Thus, it may be advantageous that no steam is added in process step b1) or that the wood is not moistened before or during process step b1).

In this step, a steam distillation or partial steam distillation may thus be performed by removing a defined amount of steam.

This process step may enable the VOCs, such as terpenes, to be effectively removed from the wood product. This is because it can be exploited that VOCs form a heteroazeotrope with water and may therefore be removed from the wood comparatively easily and at low temperatures. For example, the boiling point of alpha-pinene, an important terpene, in a mixture with water at a pressure of p=1 bar drops from 155° C. to about 95° C. when forming a heteroazeotrope. The same is also possible with hexanoic acid (caprylic acid) and all high-boiling, non-polar substances, such as hexanal, oils/fats or fatty acids. Hexanoic acid, which is contained, for example, in linseed oil, serves as a lead substance.

Here, it is provided that in process step b1), if applicable, steam is added in a predetermined first range of amounts and removed in a predetermined second range of amounts such that a lower limit and an upper limit of at least one of the first range of amounts and the second range of amounts are chosen depending on at least one specification of the wood product provided in process step a).

The disclosure is thus based, as described above, in particular on the fact that by separating steam from the process according to process step b1), VOCs may be efficiently separated from the product flow, as these accumulate in the steam of process step b1). Thus, a corresponding steam separation results in a reduction of VOC emissions, for example as exhaust gases or fumes from the manufactured product.

The process according to the disclosure offers significant advantages, in particular for the separation of VOCs from the wood, as will be explained in the following considerations.

In the related art, the entire wood is usually brought to boiling temperature for drying in order to remove the water from the wood. Exemplary boiling conditions may include 1 bar at 100° C. According to the related art, this is performed until a predeterminable target moisture is reached, without considering the contained VOCs. Assuming a typical moisture content of the wood of 50 wt. % and heating from 20° C. to 100° C., a heat amount of about 1,406,000 kJ needs to be introduced, for example using a contact dryer or a convection dryer. However, the VOCs thus expelled are very strongly diluted, so that they can hardly be isolated economically or otherwise reused.

In contrast, in order to remove according to process step b1) in a first step only the VOCs without significantly drying the wood, which can be achieved by heating the wood to 100° C. while evaporating only small amounts of water, around 1% of the total water content of the wood, a heat amount of, for example, 22,000 kJ is sufficient to remove substantially all VOCs under comparable conditions. Here, the fact is exploited that step b1) can be complete after the removal of the VOCs regardless of the residual moisture of the wood. This shows that VOCs can be removed from the wood with a dryer that can be run in a very low energy manner and also requires very little installation space, wherein an amount of steam highly concentrated in VOCs is generated.

The heating of the wood to remove the VOCs according to process step b1) may be done in various ways, such as by supplying heat through contact, preferably under almost complete exclusion of air. Then, more preferably, wood oil may be obtained with the steam. The latter is also possible by heating by means of adding steam. Here, superheated steam, for example at temperatures of 140° C., may be used, wherein avoiding condensation may be preferred. Furthermore, heating may be achieved by supplying warm air, for example at temperatures of 160° C. Again, wood oil may be obtained through condensation.

Surprisingly, it has thus been found that it is not necessary to continuously separate large amounts of steam from the process in order to achieve a significant reduction in VOC emissions. On the contrary, it has been found that even by separation of comparatively small amounts of steam almost the entire amount of VOCs, especially terpenes, can be removed. This allows to significantly reduce the amount of steam removed and thus, for example, the amount of steam to be further processed. This may reduce the complexity and thus costs of the overall process. The same applies to the amount of steam supplied, as it should be sufficiently large to effectively remove the VOCs but should be as small as possible in order to keep the installed size of the dryer and the energy requirements for step b1) or, in case of condensation of at least part of the steam supplied in step b1), the energy expenditure in step b2) as low as possible.

In the process described herein it is also exploited that, even though terpenes as the most important VOC in this process have a boiling point of higher than 150° C., it has been found that even exhaust steam flows or generally steam flows with temperatures below 100° C. may contain considerable amounts of volatile organic substances, especially terpenes. This is due to the formation of the heteroazeotropes as described above. Therefore, in the process described herein, it is advantageous to focus on the total amount of steam separated regardless of its origin or the local separation point.

Here, the separation of steam flows may basically be carried out using techniques from the related art, and it is advantageous that the steam for collecting VOCs is treated and not released into the environment along with the VOCs. For example, the steam may be separated by means of overpressure or negative pressure.

That in process step b1) steam is optionally added in a predetermined first range of amounts and removed in a predetermined second range of amounts such that a lower limit and an upper limit of at least one of the first range of amounts and the second range of amounts are chosen depending on at least one specification of the wood product provided in process step a) can be implementable in various ways as described in more detail below.

After the first drying step, i.e. process step b1), in which the VOCs were substantially removed from the wood of the wood products, a further drying step is carried out according to process step b2), namely the drying of the wood product by removing a second amount of steam until a predeterminable target moisture is reached. Here, the target moisture is the moisture content in the wood product that can or should be set by the drying.

This second drying step may be carried out, as is generally known for such wood products, in order to get the wood products to the desired residual moisture. In particular, this step may also be carried out using heat or using a conventional technical drying apparatus.

By this two-stage drying with steps b1) and b2), the VOC content may thus initially be significantly reduced by a partial steam distillation. Of course, this allows to significantly reduce the emissions of the dried wood products, whether in indoor spaces or further processing steps. Here, process step b1) may be tailored to the removal of VOCs, which may combine low energy use with efficient VOC removal.

In step b2) drying may then be carried out in the usual manner to achieve the desired final moisture.

The configuration of the drying as a two-stage process may also enable a particularly simple implementation in existing processes, as the partial steam distillation according to step b1) may be easily inserted before the usual step b2). This may be done, for example, by inserting an additional dryer upstream of the actual dryer of conventional processes. The additional dryer introduced may have very small dimensions, for example in a range of less than or equal to 5 vol. % drying volume compared to a conventional dryer. This is because the dwell time of the wood in the dryer required for step b1) is extremely short, to allow a large amount of VOCs to be removed very quickly. In addition, a very small amount of energy is sufficient to remove the VOCs.

A particularly simple collection of the VOCs may also be achieved by a step b1) that is, in particular, spatially separated from the process b2), the collected amount of steam being very small, in particular in comparison to the possibility of collecting the whole amount of steam generated during the entire drying. An efficient collection of the VOCs from the steam flow of a conventional dryer is not feasible in practice. According to the disclosure, however, it is possible to collect the removed VOCs and then, for example, reuse them without any issues. Also, the concentration of VOCs in the amount of steam separated at b1) is comparatively high, so isolation is simplified. However, within the scope of the present disclosure, it is not excluded that the steps b1) and b2) are carried out consecutively in a dryer.

Finally, the process may be carried out in a particularly low energy manner and thus in a resource-saving manner, since only a small energy input is required to evaporate the VOCs and remove them from the wood due to the formation of a heteroazeotrope as described above.

Depending on the type of heating, internal heat recovery may of course take place, e.g., by cooling waste air or waste steam.

The separation of the steam and thus the process steps b1) and b2) may preferably be carried out continuously. Continuous separation of the steam, for example, includes uninterrupted separation or continual periodic separation, i.e. including definable periodically recurring pauses.

The present process also offers advantages over processes known from the related art. For example, it is known to carry out a process referred to as UTWS drying or eco dry, in which unwanted substances are removed with high energy. However, in this process, the entire drying is performed using superheated steam. Introduced air complicates the condensation. Conversion of existing plants is rarely possible technically and in effect not reasonable commercially. In contrast, the process according to the disclosure allows significantly shorter dwell times in the dryer for step b1), smaller separated amounts of gas in the VOC separation, and improved condensation conditions. From the manufacture of pellets, for example, drying with superheated steam is known. However, similar to the UWTS process, the entire drying is carried out using superheated steam, which also leads to the disclosure having the advantages described above over this process.

With regard to the at least one specification of the wood products, it should be mentioned that one specification may serve as the basis for determining the amount of steam to be added and/or separated, or preferably a plurality of specifications may serve as the basis for determining the amount of steam to be added and/or separated.

For example, one specification or a plurality of specifications may be selected from the following specifications.

Preferably, a lower limit and an upper limit of the range of amounts of at least one of the steam optionally added in process step b1) and the steam separated in process step b1), and thus a lower limit and an upper limit of at least one of the first and second ranges of amounts, may be effected depending on the amount of wood provided in process step a) in the wood product. The amount of both the wood and the steam, e.g. in batch processing, may be the absolute amount, or the amount of both the wood and the steam in continuous processing may be the amount per unit of time. It is understandable that, regardless of the specific configuration and the components of the wood product, the amount of wood has a significant influence on the VOCs introduced into the process by the wood and thus equally on the VOCs to be discharged, such that the amount of wood in the wood product should preferably be taken into account when determining the amount of steam to be separated.

The amount of wood may be important both for the amount of steam introduced and the amount of steam output. This ensures that, on the one hand, the VOCs are removed as completely as possible and, on the other hand, unused steam introduced in b1) does not need to be removed again unduly in process step b2).

It may further be preferred that a lower limit and an upper limit of the range of amounts of at least one of the steam added in process step b1) and the steam separated in process step b1), and thus a lower limit and an upper limit of at least one of the first and second ranges of amounts, are effected depending on the amount of VOCs, in particular terpenes and/or fatty acids or fats, contained in the wood product provided in process step a).

In this configuration, it may be determined or estimated, in particular, what amount of VOCs, for example terpenes and/or fatty acids or fats, are contained in the wood product per amount thereof. In other words, the amount of VOCs present in the wood product in weight percent based on the amount of wood product may be considered.

This specification may be particularly advantageous, as it has been shown that different types of wood also have different amounts of VOCs. Accordingly, the amount of VOCs present in a certain amount of wood may depend on the specific type of wood used.

In particular, by selecting such specifications, the amount of steam that might need to be introduced and/or separated can be reduced particularly reliably, as it is ensured that not too little steam is separated due to variations in the components present during the separation of the steam and thus an undesirably high amount of VOCs is released. In addition, the amount of steam to be separated and possibly to be produced can still be reliably reduced without the aforementioned risk.

With regard to the determination of the amount of VOCs contained in the wood product, it may further be preferred that the amount of VOCs contained in the wood product provided in process step a) is determined by an examination of the wood product used or is estimated based on the type of the wood product used, in particular the wood contained.

Determining the amount of VOCs by examining the wood product may enable a particularly accurate determination of the VOCs contained in the wood product, such that the determination of the amount of steam to be introduced and/or separated can also be performed very accurately. Here, the respective amount may be determined in a known manner by an analysis of the components of the wood product. This may be advantageous, for example, because the content of VOCs might be reduced by the emission of fumes during storage or due to variations of the VOCs contained in the same type of wood.

An estimation of the components of VOCs contained in the wood product based on the type of the wood product used, in particular considering which type of wood the wood product comprises, may allow a particularly simple determination of the components while keeping the effort very low. This configuration may be based in particular on the fact that different types of wood, such as birch or spruce, often have different amounts of VOCs, yet the amount contained is characteristic of the type of wood. Therefore, knowing which wood is used, the amount of VOCs can be estimated in advance without having to perform analytics.

To ensure that potential inaccuracies of the amount in the respective wood are not critical, the amount of added and/or separated steam may be determined using a definable safety factor, i.e., an amount of steam may be added and/or separated that is definably larger than necessary according to the data of the ranges of amounts. This also allows for a particularly safe and reliable reduction in the amount of VOCs and/or fatty acids removed from the process.

It may further be preferred that the total amount of steam separated in process step b1) is in a range of amounts from 0.5 to 100 times the mass, preferably 0.5 to 50 times the mass, more preferably 0.5 to 10 times the mass, based on the amount of VOCs in the provided wood product.

The amount of steam to be supplied may be in a similar range to the amount of steam removed. However, this depends on the process control and the type of heat supply. For example, it is conceivable to heat the wood product under extensive or (almost) complete exclusion of air and only convert the water contained in the wood into the vaporous state. Alternatively, heating may be performed by saturated or superheated steam. If the latter is the case, then the amount of steam to be supplied is correspondingly higher. It follows that the range of amounts of steam to be supplied is in a range of amounts from 0 to 300 times the mass, preferably 0 to 150 times the mass, more preferably 0 to 30 times the mass, based on the amount of VOCs in the provided wood product.

This amount is significantly below the amount of steam that would be separated if the wood product were dried to the final moisture in a single drying step, but surprisingly it is sufficient to substantially remove the total amount of VOCs or fatty acids from the wood product and thus significantly reduce the VOC emissions in the process described here. Thus, it has been shown, for example, that when the process described herein or the amount of steam separated in the process is adjusted accordingly, separating a surprisingly small amount of steam is sufficient to solve the object of the disclosure.

Alternatively or additionally, it may be preferred that the total amount of steam separated in process step b1) is in a range of amounts from 0.001 to 0.2 times the mass, preferably 0.001 to 0.1 times the mass, more preferably 0.001 to 0.02 times the mass, based on the dry mass of the provided wood product.

The introduced amount of steam is in a range of amounts from 0 to 0.6 times the mass, preferably 0 to 0.3 times the mass, more preferably 0 to 0.1 times the mass, based on the dry mass of the provided wood product.

This configuration is based on the fact that the dry mass of the wood product can also be a good indicator for determining the amount of steam that might need to be introduced and/or separated. Even with such a correlation, the amount of steam to be separated is significantly below the amount used in solutions from the related art using a single-step drying, but is, also surprisingly, sufficient to remove almost the entire amount of VOCs from the process and thus significantly reduce the VOC emissions in the process for manufacturing wood products described herein.

Here, the dry mass of the wood product or the wood refers in particular to absolutely dry wood, as is general custom in wood processing. The dry mass of wood used may in turn be determined analytically or estimated based on known data for the type of wood used. Furthermore, in continuous or batch processes the mass may be determined without any issues as an amount per unit of time or as an absolute amount, as described above.

Purely by way of example, such small amounts in process step b1) allow for dwell times in a dryer of a few seconds, for example less than 10 seconds. This is made possible because, for example, a drying by only a few % is sufficient, for example 3%. This also allows the use of dryers with small volumes. This demonstrates the problem-free implementation in existing processes with small installed sizes and thus correspondingly low investment costs.

It may further be preferred that process step b1) is performed at least partially under the exclusion of air. In this configuration, it may be exploited that the amount of water present in the wood may suffice as a carrier substance for the VOCs.

Regarding the separation of the steam in process step b1), it may further be preferred that steam removed in process step b1) is continuously separated from the process at at least one steam emission location. This allows for a particularly efficient process and may be carried out under stationary conditions without much control effort.

It may further be preferred that the VOC-containing steam removed according to process step b1) is collected and, if applicable, one or more components are further treated. In this configuration, the process may thus not only serve to reduce the VOC emissions but also be performed much more economically due to the possibility of collecting separated steam flows and, if applicable, treating them further. This is because the materials contained in the steam flow or other properties of the steam flow, such as its heat, may be used in the process or other processes, such that costs and resources can be saved.

For example, it may be advantageous that, as further treatment, a mixture of terpenes or turpentine oil is isolated. Additionally or alternatively, it may be advantageous that, as a further treatment, a mixture of fatty acids or other organic substances is isolated. While such substances should indeed be reduced as emissions of the process to prevent their release into the environment, these substances may be valuable products for other processes or applications. The same applies, of course, if the individual substances are further isolated. Thus, this configuration may be particularly advantageous in regard to the economy of the process described herein and in regard to the value creation of the wood used. The same applies if, as further treatment, a hydrolate is isolated. Within the meaning of the disclosure, a hydrolate is generally understood to be the aqueous phase obtained after condensation of the steam and separation of water-insoluble substances, and may correspondingly contain water-soluble components, such as formaldehyde or short-chain organic acids or the like.

Furthermore, it may be advantageous that the separated steam or one or more components are further treated by combustion or exposure to high temperatures, adsorption, absorption, membrane technology techniques, condensation, crystallization, or other suitable process engineering techniques.

The combustion or exposure to high temperatures allows, for example, a thermal afterburning and thereby possibly an energetic use of the VOCs contained in the separated steam flow. The other mentioned techniques may each refer to isolating or separating individual substances.

It may further be preferred that at least one of the heat of a material flow occurring in the process and the heat of a separated steam flow is energetically reused in the process. In this configuration, the energy inherent in the material flow in the form of heat may thus be reused, in particular to heat other material flows or to perform the drying. This step too may improve economic aspects of the process according to the disclosure and thus save costs and resources.

It may further be preferred that the drying in the first drying stage is performed at a temperature 100° C., preferably 125⁰, more preferably 150° C. Surprisingly, it has been shown that at this temperature the VOCs to be removed emerge more strongly from the timber. This allows to keep the dwell time in the first drying stage short and still remove the vast majority of the VOCs. The dwell time in the first drying stage may, for example, be in a range between preferably 0.5% to s 30% of the total drying time, more preferably between 1.5% to s 25%, even more preferably between 3% to 20% of the total drying time.

It may further be preferred that the drying in the first drying stage is performed in a circulating air mode, in which the released vapours remain substantially within the drying device. This may result in a highly steam-containing drying atmosphere, in which the VOCs can be driven out of the timber in the form of a heteroazeotrope together with water.

Furthermore, it may preferably be provided that the fresh air fraction in the circulating air mode is s 20%, preferably s 10%, based on the total volume of the drying device of the first drying stage.

In a further configuration of the process, it may be provided that the supply and/or discharge of the wood products into or out of the first drying stage is performed via a substantially airtight lock. This may advantageously ensure that the drying atmosphere in the first drying stage optimally supports VOC emission from the timber.

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of selected embodiments and not all possible implementations, and are not intended to limit the scope of the present disclosure.

Below, the disclosure will be explained by way of example with reference to the accompanying drawing using preferred exemplary embodiments, wherein the features represented below may represent an aspect of the disclosure both individually and in combination.

FIG. 1 shows a schematic representation of a process according to the present disclosure.

### DETAILED DESCRIPTION

Example embodiments will now be described more fully with reference to the accompanying drawing.

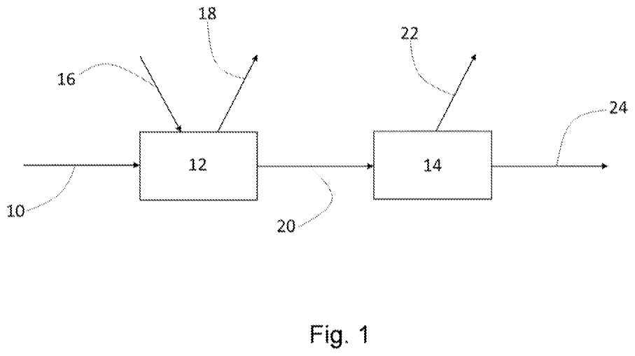

In FIG. 1, a process according to a configuration of the present disclosure is shown schematically.

The arrow 10 intends to represent that a wood product is provided. The wood product has, in particular, been formed by a drying process and is to be further dried. For this purpose, two dryers 12, 14 are provided. The drying is thus performed in two stages, wherein in the dryer 12 optionally steam is added to the wood product in a first range of amounts, which is intended to be represented by arrow 16, and wherein the wood product is dried by removing a second range of amounts of steam. The latter is intended to be represented by arrow 18. Due to this, heteroazeotropes form from the VOCs present in the wood product and the water and are output together with the steam. Here, steam is optionally added in a predetermined first range of amounts and removed in a predetermined second range of amounts such that a lower limit and an upper limit of at least one of the first range of amounts and the second range of amounts are chosen depending on at least one specification of the provided wood product.

From the first dryer 12 the surface-dried and VOC-depleted wood product is guided to the second dryer 14, as intended to be indicated by arrow 20. The second dryer 14 dries the wood product by removing a second amount of steam until a predeterminable target moisture is reached, as intended to be indicated by arrow 22.

After the dryer 14 the wood product now having its final moisture is provided, as shown by arrow 24.

After the wood product with final moisture is provided, the wood product may be complete or may be further processed.

Furthermore, the removed VOC-containing steam may be collected and, if applicable, one or more components may be further treated.

### Example 1

1 t of pine wood flakes (absolutely dry mass) with a wood moisture (load, u) of u=85% are dried in two stages. In a first drying stage, starting from the load u=85% and according to the specification to be considered, 20% of the initial moisture is removed, so that after the first drying stage the load u=65%. In an additional drying stage, starting from the load u=65% achieved in the first drying stage, drying is performed until the target moisture of u=3% is reached. The vapours of the first drying stage are combusted. At the exhaust chimney of the second drying stage, a VOC concentration of 132 mg/m³ is measured, whereas in a direct single-stage drying to a target moisture of u=3%, a VOC concentration of 406 mg/m³ was measured at the exhaust chimney of the drying stage.

### Example 2

1 t of pine wood flakes (absolutely dry mass) with a wood moisture (load, u) of u=82% are dried in two stages. In a first drying stage, the pine wood flakes are stripped of moisture (water) equivalent to 0.15 times their dry mass. In an additional drying stage, starting from the dry mass achieved in the first drying stage, drying is performed until the target moisture is reached. The untreated flakes have a terpene content of 3.2 kg/t absolutely dry. After the first drying stage, a terpene content of 1.36 kg/t absolutely dry is measured.

### Example 3

1 t of pine wood flakes (absolutely dry mass) with a wood moisture (load, u) of u=82% are dried in two stages. The untreated flakes have a terpene content of 3.08 kg/t absolutely dry. In a first drying stage, the pine wood flakes are stripped of water equivalent to 49 times their terpene content, i.e. 3.08×49=150.9 kg/t of water. Then, drying is performed until the target moisture is reached. After the first drying stage, a terpene content of 1.36 kg/t absolutely dry is measured, which corresponds to a reduction of the terpene content compared to the untreated flakes of about 56 wt. % based on the total terpene content.

### Example 4

1 t of pine wood flakes (absolutely dry mass) with a moisture u=79% and a terpene content of 3.08 kg/t absolutely dry are dried in a first drying stage in a drum dryer under the exclusion of fresh air at a temperature of 124° C. until a load u=61% is reached. Here, the drum dryer is a pure contact dryer. The resulting vapours are condensed. After drying to a load u=61%, the flakes have a reduced terpene content of 0.56 kg/t absolutely dry. This corresponds to a reduction of the terpene content of about 82 wt. %.

### Example 5

1 t of pine wood flakes (absolutely dry mass) with a moisture u=79% and a terpene content of 3.08 kg/t absolutely dry are dried in a drum dryer under the exclusion of fresh air at a temperature of 124° C. until a moisture of u=61% is reached. Here, the drum dryer is a pure contact dryer. The resulting vapours are condensed. After drying, the flakes have a reduced terpene content of 0.56 kg/t absolutely dry. Due to drawn-in “leakage air” (fresh air), the vapours have an air fraction of 18.5 wt. % or 91.5 wt. % water and thus a dew point of 96° C. By cooling these vapours to 50° C., a water content in the air of 8 wt. % is set. The organic components contained in the vapours are also condensed. A large part thereof may be separated as an organic light phase. A subsequent analysis of the organic phase shows that it contains the terpenes alpha-pinene, beta-pinene, delta-3-carene, and limonene as well as hexanoic acid (caproic acid), caproaldehyde, and linolenic acid. A corresponding analysis of the aqueous phase (after separation of the organic phase) has shown that it contains alpha-terpineol, beta-terpineol, vanillin, coniferyl aldehyde, C4-, C6-, C8-, C16-fatty acid methyl esters. The cooling of the vapours is performed using a countercurrent of fresh air. The utilized fresh air may be utilized as supply air for a second drying stage to utilize the thermal energy content of the vapours for preheating the fresh air.

### Example 6

In an existing plant for drying flakes, an additional dryer is retrofitted. The additional dryer is inserted upstream of the existing plant. In it, flakes are dried from a moisture of u=91% to a moisture of u=81% and subsequently in the second drying stage (main dryer) to a moisture of u=3%. The heat demand for heating and evaporating the corresponding first partial amount is 25% of the total heat demand. Since in the second stage mainly capillary moisture is removed and also the material to be dried is hygroscopic, the first drying (b1) requires only 5% of the dwell time compared to the second drying (b2). While the dryer of stage 2 (main dryer) is operated with a dwell time of 1225 seconds (about 20 minutes), a dwell time of 58 seconds is sufficient for the first drying stage. As such, the necessary installed size is correspondingly smaller.

### Example 7

In an existing plant for drying flakes, an additional dryer is retrofitted. The retrofitted dryer is inserted upstream of the existing dryer. This retrofitted dryer is configured as a directly heated drum dryer with a gas inlet temperature of 298° C. The installation size is about 5.1 vol. % of the main dryer (existing dryer). The vapours removed from the retrofitted dryer are combusted.

### Example 8

In an existing plant for drying flakes, an additional dryer is retrofitted. The retrofitted dryer is inserted upstream of the existing dryer. This retrofitted dryer is configured as an indirectly heated drum dryer with a heating temperature of 190° C. and is a contact dryer. The installation size is about 6.2 vol. % of the main dryer (existing dryer). The vapours removed from the retrofitted dryer are combusted.

### Example 9

In an existing plant for drying flakes, an additional dryer is retrofitted. The retrofitted dryer is inserted upstream of the existing dryer. Here, the retrofitted dryer is configured as an indirectly heated drum dryer with a heating temperature of 185° C. and is a contact dryer. The vapours removed from this dryer are returned to a mixing chamber. The water content of the vapours is 65.8%. Thus, the dew point of these vapours is 92° C. The installation size is about 5.9 vol. % of the main dryer's (existing dryer). The vapours removed from the retrofitted dryer are condensed at 50° C. The obtained condensate is used as fuel for heating the air supplied to the main dryer (existing dryer).

### Example 10

In an existing plant for drying flakes, an additional dryer is retrofitted. The retrofitted dryer is inserted upstream of the existing dryer as an indirectly heated belt dryer with a heating temperature of 120° C. and is configured as a convection dryer. The vapours removed from this retrofitted dryer are returned to a mixing chamber. The water content of the vapours is 65.8%. Thus, the dew point of these vapours is 92° C. The vapours are condensed at 50° C.

### Example 11

In an existing plant for drying OSB strands (coarse flakes), an additional dryer is retrofitted. The retrofitted dryer is inserted upstream of the existing dryer and, as an indirectly heated belt dryer with a heating temperature of 90° C., is configured as a convection dryer. The vapours removed from this dryer are returned to a mixing chamber. The water content of the vapours is 45.3%. Thus, the dew point of these vapours is 85° C. The vapours removed from the process are combusted.

### Example 12

An intermittently operating chamber dryer for pine sawn timber is operated over a period of 36 h. The drying takes place in a circulating air drying chamber at a maximum of 85° C. An additional drying stage is added to the beginning of the drying schedule. There, the sawn timber is first heated to 85° C., mostly under circulating air conditions. At this time, so few vapours are removed that the relative humidity is maintained at almost 100%. Thus, the vapours have a water content of 45.9%. During this time, the wood moisture decreases from u=85% to u=71%. The removed vapours are further treated and either condensed or combusted. The terpene content of the sawn timber decreases from 3.1 kg/t absolutely dry to a value of 0.5 kg/t absolutely dry. The duration of the first (newly provided) drying stage is 190 minutes or 8.8% of the total drying time (drying schedule). After the newly introduced drying stage, the drying schedule is finalized as usual. The vapours removed at this stage are released into the environment untreated. They have a VOC content reduced by 72 wt. %.

The foregoing description of the embodiment has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A process for drying wood products, wherein the process comprises the following process steps:
a) providing a wood product,
b) drying the wood product by thermal treatment; wherein process step b) is performed in two stages and comprises at least the following steps:
b1) if applicable, adding steam to the wood product and drying the wood product by removing a first amount of steam; and
b2) drying the wood product by removing a second amount of steam until a predeterminable target moisture is reached, wherein
in process step b1), if applicable, steam is added in a predetermined first range of amounts and removed in a predetermined second range of amounts such that a lower limit and an upper limit of at least one of the first range of amounts and the second range of amounts are chosen depending on at least one specification of the wood product provided in process step a).

2. The process according to claim 1, wherein a lower limit and an upper limit of at least one of the first and the second ranges of amounts are effected depending on the amount of wood provided in process step a) in the wood products.

3. The process according to claim 1, wherein a lower limit and an upper limit of at least one of the first and the second ranges of amounts are effected depending on the amount of VOCs contained in the wood product provided in process step a).

4. The process according to claim 3, wherein the amount of VOCs contained in the wood product provided in process step a) is determined by an examination of the wood product used or is estimated based on the type of the wood product used, in particular the wood contained.

5. The process according to claim 1, wherein the total amount of steam removed in process step b1) is in a range of amounts from 0.5 to 100 times the mass based on the amount of VOCs of the provided wood product.

6. The process according to claim 1, wherein the total amount of steam separated in process step b1) is in a range of amounts from 0.001 to 0.2 times the mass based on the dry mass of the provided wood product.

7. The process according to claim 1, wherein no steam is added in process step b1).

8. The process according to claim 3, wherein at least one of terpenes and fatty acids is considered as VOCs.

9. The process according to claim 1, wherein process step b1) is at least partially performed under the exclusion of air.

10. The process according to claim 1, wherein steam removed in process step b1) is continuously removed from the process at at least one steam emission location.

11. The process according to claim 1, wherein the VOC-containing steam removed according to process step b1) is collected and, if applicable, one or more components are further treated.

12. The process according to claim 11, wherein, as further treatment, a mixture of terpenes or turpentine oil is isolated.

13. The process according to claim 11, wherein, as further treatment, a mixture of fatty acids or other organic substances is isolated.

14. The process according to claim 11, wherein, as further treatment, a hydrolate is isolated.

15. The process according to claim 11, wherein the separated steam or one or more components are further treated by combustion or exposure to high temperatures, adsorption, absorption, membrane technology techniques, condensation, or crystallization.

16. The process according to claim 1, wherein at least one of the heat of a material flow occurring in the process and the heat of a separated steam flow is energetically reused in the process.

17. The process according to claim 1, wherein the process steps b1) and b2) are performed in two consecutive drying devices.

18. The process according to claim 1, wherein the wood product is a wood-containing product produced in a dry process.

19. The process according to claim 1, wherein the drying in the first drying stage is performed at a temperature ≥100° C.

20. The process according to claim 1, wherein the drying in the first drying stage is performed in a circulating air mode, in which the released vapours remain substantially within the drying device.

21. The process according to claim 20, wherein the fresh air fraction in the circulating air mode is 20%, based on the total volume of the drying device of the first drying stage.

22. The process according to claim 1, wherein the supply and/or discharge of the wood products into or out of the first drying stage are performed via a substantially airtight lock.
